(19) United States
(12) Patent Application Publication
(10) Pub. No.: US 2024/0097122 A1
(43) Pub. Date: Mar. 21, 2024

(54) LITHIUM NICKEL-BASED COMPOSITE OXIDE AS A POSITIVE ELECTRODE ACTIVE MATERIAL FOR RECHARGEABLE LITHIUM-ION BATTERIES

(71) Applicants: UMICORE, Brussels (BE); UMICORE KOREA LTD., Chungcheongnam-do (KR)

(72) Inventors: KyungSub JUNG, Chungcheongnam-do (KR); Maxime BLANGERO, Chungcheongnam-do (KR); Olesia KARAKULINA, Chungcheongnam-do (KR); Woon-Hyoung RYU, Chungcheongnam-do (KR); Ji-Yeong KWON, Chungcheongnam-do (KR)

(21) Appl. No.: 18/268,302

(22) PCT Filed: Oct. 26, 2021
(86) PCT No.: PCT/EP2021/079617

§ 371 Date: Jun. 19, 2023

(30) Foreign Application Priority Data
Dec. 21, 2020 (EP) 20215924.0

(51) Int. Cl. H01M 4/38; H01M 4/485; H01M 4/58; H01M 10/0525

(52) U.S. Cl. CPC H01M 4/382; H01M 4/485; H01M 4/5815; H01M 10/0525; H01M 2004/028

(57) ABSTRACT

The present invention provides a positive electrode active material powder for lithium-ion rechargeable batteries, wherein the positive electrode active material comprises Li, M′, S and O, wherein M′ consists of:
Ni in a content x between 60.0 mol % and 95.0 mol %, relative to M′
Co in a content y between 0.0 mol % and 25.0 mol %, relative to M′,
Mn in a content z between 0.0 mol % and 25.0 mol %, relative to M′,
W in a content a of 0.05 mol % or more, relative to M′
D in a content b between 0.0 mol % and 2.0 mol %, relative to M′, wherein D comprises at least one element of the group consisting of: Al, B, Ba, Ca, Cr, F, Fe, Mg, Mo, Nb, Si, Sr, Ti, Y, V, Zn and Zr, and,
wherein x, y, z, a, and b are measured by ICP,
wherein x+y+z+a+b is 100.0 mol %,
wherein the positive electrode active material comprises soluble sulfur in a content of 0.30 mol % or more, relative to M′.

### TECHNICAL FIELD AND BACKGROUND

This invention relates to a lithium nickel-based oxide positive electrode active material for lithium-ion secondary batteries (LIBs) suitable for electric vehicle (EV) and hybrid electric vehicle (HEV) applications, comprising lithium transition metal-based oxide particles comprising soluble sulfur, also referred as sulfate ions (SO₄²⁻).

A positive electrode active material is defined as a material which is electrochemically active in a positive electrode. By active material, it must be understood a material capable to capture and release Li ions when subjected to a voltage change over a predetermined period of time.

In particular, the present invention concerns a high nickel-based oxide positive electrode active material—hereafter referred to as “high Ni compound”—i.e. a high Ni compound wherein the atomic ratio of Ni to M′ is of at least 75.0% (or 75.0 at %), preferably of at least 77.5% (or 77.5 at %), more preferably of at least 80% (or 80.0 at %).

In the framework of the present invention, at % signifies atomic percentage. The at % or “atom percent” of a given element expression of a concentration means how many percent of all atoms in the claimed compound are atoms of said element.

The weight percent (wt %) of a first element E (E_{wt1}) in a material can be converted from a given atomic percent (at %) of said first element E (Eₐₜ₁) in said material by applying the following formula:

$${E}_{wt 1} = \frac{( {E}_{at 1} \times {E}_{aw 1} )}{{\sum }_{i = 1}^{n} ( {E}_{ati} \times {E}_{awi} )} \times 100 \% ,$$

wherein the product of Eₐₜ₁ with E_{aw1}, E_{aw1} being the atomic weight (or molecular weight) of the first element E, is divided by the sum of Eₐₜᵢ×E_{awi} for the other elements in the material. n is an integer which represents the number of different elements included in the material.

Along with the developments of EVs and HEVs, it comes a demand for lithium-ion batteries eligible for such applications and the high Ni-class of compounds is more and more explored as a solid candidate to be used as positive electrode active materials of LIBs, because of its relatively cheap cost (with respect to alternatives such as lithium cobalt-based oxides, etc.) and higher capacities at higher operating voltages.

Such a high Ni compound is already known, for example, from the document JP5584456B2—hereafter referred to as “JP'456”—or JP5251401B2—hereafter referred to as “JP'401”—.

JP'456 discloses a high Ni compound having SO₄²⁻ ion (e.g. sulfuric acid radicals according to JP'456 phrasing) on top of the particles of said high Ni compound in a content ranging from 1000 ppm to 4000 ppm. The calculated molar content of soluble sulfur ranges from 0.1 mol % to 0.4 mol % with respect to the total molar content of Ni, Co, and Mn. JP'456 explains that when the amount of sulfuric acid radicals is within the above-mentioned range, there is an increase in the capacity retention rate and the discharge capacity properties of the compound. However, if the amount of sulfuric acid radicals is less than the above-mentioned range, there is a reduction in the capacity retention rate, while if this amount exceeds the above-mentioned range, there is a reduction of the discharge capacity.

JP'401 teaches that applying a sulfate coating, in particular a lithium sulfate coating, on primary particles allows to design secondary particles, resulting from the aggregation of said sulfate coated primary particles, having a specific pore structure allowing to confer to the high Ni compound made from said secondary particles higher cycle durability and a higher initial discharge capacity. JP'401 explains moreover that such specific pore structure is achieved once said sulfate coating is washed and removed.

Although high Ni compounds are promising for the above-mentioned advantages, they also present disadvantages such as a deterioration of the cycling stability, due to their high Ni contents.

As an illustration of these drawbacks, the high Ni compounds of the prior art have either a low first discharge capacity which is not superior to 180 mAh/g (JP'456) or a limited capacity retention of maximum 86% (JP'401).

Presently, there is therefore a need to achieve high Ni compounds having sufficiently high first discharge capacity (i.e. of at least 207 mAh/g), which is, according to the present invention, a prerequisite for the use of such a high Ni compound in LIBs suitable for (H)EV applications.

It is an object of the present invention to provide a positive electrode active material having an improved first charge capacity of at least 207 mAh/g.

### Acknowledgement

This invention was made with the support from Materials/Parts Technology Development Program through Korea evaluation institute of industrial technology funded by Ministry of Trade, Industry and Energy (MOTIE, Republic of Korea). [Project Name: Development of high power (high discharge rate) lithium-ion secondary batteries with 8C-rate class/Project Number: 20011287/Contribution rate: 100%]

### SUMMARY OF THE INVENTION

This objective is achieved by providing a positive electrode active material for lithium-ion batteries, wherein the positive electrode active material comprises Li, M′, S and O, wherein M′ consists of:
Ni in a content x between 60.0 mol % and 95.0 mol %, relative to M′
Co in a content y between 0.0 mol % and 25.0 mol %, relative to M′,
Mn in a content z between 0.0 mol % and 25.0 mol %, relative to M′,
W in a content a between 0.05 mol % and 0.50 mol %, relative to M′,
D in a content b between 0.0 mol % and 2.0 mol %, relative to M′, wherein D comprises at least one element of the group consisting of: Al, B, Ba, Ca, Cr, F, Fe, Mg, Mo, Nb, Si, Sr, Ti, Y, V, Zn and Zr, and,
wherein x, y, z, a, and b are measured by ICP,
wherein x+y+z+a+b is 100.0 mol %,
   wherein the positive electrode active material comprises soluble sulfur in a content between 0.30 mol % and 2.00 mol %, relative to M′.

Note that when an element is stated to be present in a content between 0.0 mol % and another numerical value, this means that said element may not be present at all, in other words, that said element is optional.

Preferably, the soluble sulfur can be associated to a SO₄²⁻ or a sulfate form, more precisely as a sulfate salt like a Li₂SO₄ form as determined by XPS. Soluble sulfur can also be associated to a SO₃²⁻ or a sulfite form, more precisely as a sulfite salt.

The soluble sulfur content is easily determined by an ICP analysis after washing of the positive electrode active material of the invention with water according to the session A) ICP analysis in the detailed description.

In the framework of the present invention, ppm means parts-per-million for a unit of concentration, expressing 1 ppm=0.0001 wt %.

Moreover, in the framework of the present invention, the term “sulfur” refers to the presence of sulfur atoms or sulfur element in the claimed positive electrode active material.

The present invention concerns the following embodiments:

### Embodiment 1

In a first aspect, the present invention concerns a positive electrode active material for lithium-ion batteries, wherein the positive electrode active material comprises Li, M′, S and O, wherein M′ consists of:
Ni in a content x between 60.0 mol % and 95.0 mol %, relative to M′
Co in a content y between 0.0 mol % and 25.0 mol %, relative to M′,
Mn in a content z between 0.0 mol % and 25.0 mol %, relative to M′,
W in a content a of 0.05 or more, relative to M′,
D in a content b between 0.0 mol % and 2.0 mol %, relative to M′, wherein D comprises at least one element of the group consisting of: Al, B, Ba, Ca, Cr, F, Fe, Mg, Mo, Nb, Si, Sr, Ti, Y, V, Zn and Zr, and,
wherein x, y, z, a, and b are measured by ICP,
wherein x+y+z+a+b is 100.0 mol %,
   wherein the positive electrode active material comprises soluble sulfur in a content of 0.30 mol % or more, relative to M′.

Preferably, the positive electrode active material comprises soluble sulfur in a content between 0.30 mol % and 2.00 mol %, relative to M′.

Preferably, soluble sulfur is present in the positive electrode material in a content between 0.50 mol % and 1.50 mol %, relative to M′. More preferably, between 0.50 mol % and 1.00 mol %, relative to M′.

Preferably, the soluble sulfur content is equal to a decrease of S content relative to M′ as determined by ICP after having contacted several times (or dispersed) the positive electrode active material powder (in)to deionized water for at least 5 minutes (by stirring) at 25° C., filtered said positive electrode active material powder, and dried said positive electrode active material powder.

In a preferred embodiment, said Ni is present in a content x of 75 mol % or more, and preferably at least 80 mol %.

In a preferred embodiment, said Ni is present in a content x of 90 mol % or less.

In a preferred embodiment, said Co is present in a content y of 5.0 mol % or more.

In a preferred embodiment, said Co is present in a content y of 10.0 mol % or less.

In a preferred embodiment, said Ni is present in a content x of 75 mol % or more, and preferably at least 80 mol %.

Preferably, a is at most 0.50 mol %.

In a preferred embodiment, said W in a content a is between 0.05 mol % and 0.50 mol %, relative to M′

In another embodiment, said W in a content a is between 0.10 mol % and 0.30 mol % relative to M′.

### Embodiment 2

In a second embodiment, preferably according to the Embodiment 1, said positive electrode active material comprises Al in a content between 0.10 mol % and 1.00 mol % relative to M′.

Preferably, said positive electrode active material comprises Al content is between 0.20 mol % and 0.50 mol % relative to M′.

Preferably said positive electrode active material comprises Al in a content of 0.10 mol % or more, and preferably 0.20 mol % or more, relative to M′.

Preferably said positive electrode active material comprises Al in a content of at most 1.0 mol %, and preferably at most 0.50 mol %, relative to M′.

For completeness it is emphasized that Al is comprised in D, so that said content of Al is comprised in said parameter b.

Therefore, alternatively stated, in a preferred embodiment D comprises Al in a content of at most 1.0 mol %, and preferably at most 0.50 mol %, relative to M′.

Also, in a preferred embodiment D comprises Al in a content of 0.10 mol % or more, and preferably 0.20 mol % or more, relative to M′.

### Embodiment 3

In a third embodiment, preferably according to the Embodiments 1 to 2, said positive electrode active material comprises B in a content between 0.05 mol % and 1.50 mol % relative to M′.

Preferably, said positive electrode active material comprises B content in a content of at least 0.05 mol %, and more preferably at least 0.1 mol %, relative to M′.

Preferably, said positive electrode active material comprises B in a content of at most 1.5 mol %, and preferably at most 1.0 mol %, relative to M′.

For completeness it is emphasized that B is comprised in D, so that said content of B is comprised in said parameter b.

Therefore, alternatively stated, in a preferred embodiment D comprises B in a content of at most 1.5 mol %, more preferably 1.0 mol %, and even more preferably at most 0.50 mol %, relative to M′.

Also, in a preferred embodiment D comprises B in a content of 0.05 mol % or more, and preferably 0.10 mol % or more, relative to M′.

### Embodiment 4

In a third embodiment, preferably according to the Embodiments 1 to 3, said material having:
S content S_{A} and W content W_{A}, wherein S_{A} and W_{A} are determined by ICP analysis, wherein S_{A} and W_{A} are expressed as molar fractions compared to the sum of x and y and z,
an average S fraction S_{B} and an average W fraction W_{B}, wherein S_{B} and W_{B} are determined by XPS analysis, wherein S_{B} and W_{B} are expressed as molar fractions compared to the sum of the fractions of Co, Mn and Ni as measured by XPS analysis,
wherein the ratio S_{B}/S_{A}>1.0,
wherein the ratio W_{B}/W_{A}>1.0.

Preferably, the ratio S_{B}/S_{A} is at least 1.5 and at most 600 and more preferably, the ratio W_{B}/W_{A} is at least 1.5 and at most 700.

Preferably, the ratio S_{B}/S_{A} is at least 50 and at most 550, and more preferably S_{B}/S_{A} is at least 100 and at most 500.

Preferably, the ratio W_{B}/W_{A} is at least 50 and at most 700, and more preferably W_{B}/W_{A} is at least 100 and at most 650.

Note that S_{B} and S_{A} refer to total contents of sulfur and therefore are inclusive of the content of soluble sulfur.

### Embodiment 5

In a fifth embodiment, preferably according to the Embodiments 1 to 4, said material having:
Al content Al_{A}, wherein Al_{A} is determined by ICP analysis, wherein Al_{A} is expressed as molar fractions compared to the sum of x and y and z,
an average Al fraction Al_{B}, wherein Al_{B} is determined by XPS analysis, wherein Al_{B} is expressed as molar fractions compared to the sum of the fractions of Co, Mn and Ni as measured by XPS analysis,
wherein the ratio Al_{B}/Al_{A}>1.0.

Preferably, the ratio Al_{B}/Al_{A} is at least 3.0 and at most 2500.

Preferably, the ratio Al_{B}/Al_{A} is at least 200 and at most 2400, and more preferably Al_{B}/Al_{A} is at least 300 and at most 2300.

### Embodiment 6

In a sixth embodiment, preferably according to the Embodiments 1 to 5, said material having:
B content B_{A}, wherein B_{A} is determined by ICP analysis, wherein B_{A} is expressed as molar fractions compared to the sum of x and y and z,
An average B fraction B_{B}, wherein B_{B} is determined by XPS analysis, wherein B_{B} is expressed as molar fractions compared to the sum of the fractions of Co, Mn and Ni as measured by XPS analysis,
wherein the ratio B_{B}/B_{A}>1.0.

Preferably, the ratio B_{B}/B_{A} is at least 100 and at most 1500.

Preferably, the ratio B_{B}/B_{A} is at least 200 and at most 1400, and more preferably B_{B}/B_{A} is at least 300 and at most 1200.

In particular, for any of the Embodiments 1 to 6, S_{B}, W_{B}, Al_{B}, and B_{B} are the average fractions of S, W, Al, and B respectively, measured in a region of a particle of the positive electrode material powder according to invention defined between a first point of an external edge of said particle and a second point at a distance from said fist point, said distance separating said first to said second point being equal to a penetration depth of said XPS, said penetration depth D being comprised between 1.0 to 10.0 nm. In particular, the penetration depth is the distance along an axis perpendicular to a virtual line tangent to said external edge and passing trough said first point.

The external edge of the particle is, in the framework of this invention, the boundary or external limit distinguishing the particle from its external environment.

The present invention concerns a use of the positive electrode active material according to any of the preceding Embodiments 1 to 6 in a battery.

The present invention is also inclusive of a process for manufacturing the positive electrode active material according to any of the preceding Embodiments 1 to 6, comprising the steps of:
Preparing a first sintered lithium transition metal-based oxide compound,
mixing said first sintered lithium transition metal-based oxide compound with a source of tungsten, preferably with WO₃, source of sulfate ion, preferably with Al₂(SO₄)₃ and/or H₂SO₄, and with water, thereby obtaining a mixture, and
heating the mixture in an oxidizing atmosphere in a furnace at a temperature between 350° C. and less than 500° C., preferably at most 450° C., for a time between 1 hour and 20 hours so as to obtain the positive electrode active material powder according to the present invention.

Preferably, lithium metal-based oxide compound is mixed with a source of boron, preferably H₃BO₃, together with source of tungsten and a source of sulfate ion.

### BRIEF DESCRIPTION OF THE FIGURES

FIG. 1. SEM image of EX1.3

FIG. 2a. XPS spectra of Al2p and Ni3p peaks of EX1.4

FIG. 2b. XPS spectra of S2p peak of EX1.4

FIG. 2c. XPS spectra of W2f peak of EX1.4

FIG. 2d. XPS spectra of B1s peak of EX3

### DETAILED DESCRIPTION

In the drawings and the following detailed description, preferred embodiments are described so as to enable the practice of the invention. Although the invention is described with reference to these specific preferred embodiments, it will be understood that the invention is not limited to these preferred embodiments. The invention includes numerous alternatives, modifications and equivalents that are apparent from consideration of the following detailed description and accompanying drawings.

### A) ICP analysis

### A1) ICP Measurement

The Li, Ni, Mn, Co, Al, B, W, and S contents of the positive electrode active material powder are measured with the Inductively Coupled Plasma (ICP) method by using an Agillent ICP 720-ES. 2 g of product powder sample is dissolved into 10 mL of high purity hydrochloric acid in an Erlenmeyer flask. The flask is covered by a glass and heated on a hot plate at 380° C. until complete dissolution of the precursor. After being cooled to room temperature, the solution of the Erlenmeyer flask is poured into a 250 mL volumetric flask. Afterwards, the volumetric flask is filled with deionized water up to the 250 mL mark, followed by complete homogenization. An appropriate amount of solution is taken out by pipette and transferred into a 250 mL volumetric flask for the 2^{nd} dilution, where the volumetric flask is filled with internal standard and 10% hydrochloric acid up to the 250 mL mark and then homogenized. Finally, this 50 mL solution is used for ICP measurement.

### A2) Soluble Sulfur Measurement

To investigate the soluble S content in the lithium transition metal-based oxide particles according to the invention, washing and filtering processes are performed. 5 g of the positive electrode active material powder and 100 g of ultrapure water are measured out in a beaker. The electrode active material powder is dispersed in the water for 5 minutes at 25° C. using a magnetic stirrer. The dispersion is vacuum filtered, and the dried powder is analyzed by the above ICP measurement to determine the amount of soluble S containing compound.

### B) X-ray Photoelectron Spectroscopy Analysis

In the present invention, X-ray photoelectron spectroscopy (XPS) is used to analyze the surface of positive electrode active material powder particles. In XPS measurement, the signal is acquired from the first few nanometers (e.g. 1 nm to 10 nm) of the uppermost part of a sample, i.e. surface layer. Therefore, all elements measured by XPS are contained in the surface layer.

For the surface analysis of positive electrode active material powder particles, XPS measurement is carried out using a Thermo K-α+ spectrometer (Thermo Scientific, https://www.thermofisher.com/order/catalog/product/IQLAADGAAFFACVMAHV). Monochromatic Al Kα radiation (hu=1486.6 eV) is used with a spot size of 400 μm and measurement angle of 45°. A wide survey scan to identify elements present at the surface is conducted at 200 eV pass energy. C1s peak having a maximum intensity (or centered) at a binding energy of 284.8 eV is used as a calibrate peak position after data collection. Accurate narrow-scans are performed afterwards at 50 eV for at least 10 scans for each identified element to determine the precise surface composition.

Curve fitting is done with CasaXPS Version2.3.19PR1.0 (Casa Software, http://www.casaxps.com/) using a Shirley-type background treatment and Scofield sensitivity factors. The fitting parameters are according to Table 1a. Line shape GL(30) is the Gaussian/Lorentzian product formula with 70% Gaussian line and 30% Lorentzian line. LA(α, β, m) is an asymmetric line-shape where α and β define tail spreading of the peak and m define the width.

TABLE 1a
XPS fitting parameter for Ni2p3, Mn2p3, Co2p3, Al2p, S2p, W4f, and B1s.

| | Sensitivity | Fitting range | | |
|---|---|---|---|---|
| Element | factor | (eV) | Defined peak(s) | Line shape |
| Ni | 14.61 | 851.3 ± 0.1- | Ni2p3, Ni2p3 satellite | LA(1.33, 2.44, 69) |
| | | 869.4 ± 0.1 | | |
| Mn | 9.17 | 639.9 ± 0.1- | Mn2p3, Mn2p3 satellite | GL(30) |
| | | 649.5 ± 0.1 | | |
| Co | 12.62 | 775.4 ± 0.1- | Co2p3-1, Co2p3-2, Co2p3 | GL(30) |
| | | 792.7 ± 0.3 | satellite | |
| Al | 0.54 | 78.8 ± 0.1- | Al2p peak 1, Ni3p1, | GL(30) |
| | | 65.6 ± 0.1 | Ni3p3, Ni3p1 satellite, | |
| | | | Ni3p3 satellite | |
| S | 1.68 | 165.1 ± 0.1- | S2p3, S2p1 | GL(30) |
| | | 173.0 ± 0.1 | | |
| W | 9.80 | 32.1 ± 0.1- | W4f7, W4f5, and W5p3 | GL(30) |
| | | 43.1 ± 0.1 | | |
| B | 0.49 | 187.0 ± 0.1- | B1s | GL(30) |
| | | 195.7 ± 0.1 | | |

For Al, S, Co, and W peaks, constraints are set for each defined peak according to Table 1b. Ni3p (including Ni3p3, Ni3p1, Ni3p3 satellite, and Ni3p1 satellite) and W5p3 are not quantified.

TABLE 1b
XPS fitting constraints for peaks fitting.

| | | Fitting range | FWHM | |
|---|---|---|---|---|
| | | constraint | constraint | |
| Element | Defined peak | (eV) | (eV) | Area constraint |
| Al | Ni3p3 | 65.7-68.0 | 0.5-2.9 | No constraint set |
| | Ni3p1 | 68.0-70.5 | 0.5-2.9 | 50% of Ni3p3 area |
| | Ni3p3 satellite | 70.5-72.5 | 0.5-2.9 | 40% of Ni3p3 area |
| | Ni3p1 satellite | 72.5-75.0 | 0.5-2.9 | 20% of Ni3p3 area |
| | Al2p | 72.6-74.7 | 0.5-3.0 | No constraint set |
| S | S2p3 | No constraint set | 0.1-2.0 | No constraint set |
| | S2p1 | No constraint set | 0.1-2.0 | 50% of S2p3 area |
| Co | Co2p3-1 | 776.0-780.9 | 0.5-4.0 | No constraint set |
| | Co2p3-2 | 781.0-785.0 | 0.5-4.0 | No constraint set |
| | Co2p3 satellite | 785.1-792.0 | 0.5-6.0 | No constraint set |
| W | W4f7 | 33.0-36.0 | 0.2-4.0 | No constraint set |
| | W4f5 | 36.1-39.0 | Same as W4f7 | 75% of W4f7 area |
| | W5p3 | 39.1-43.0 | 0.5-2.5 | No constraint set |

The Al, S, B, and W surface contents as determined by XPS are expressed as a molar fraction of Al, S, B, and W, respectively, in the surface layer of the particles divided by the total content of Ni, Mn and Co in said surface layer. It is calculated as follows:

fraction of Al=Al_{B}=Al (at %)/(Ni (at %)+Mn (at %)+Co (at %))

fraction of S=S_{B}=S (at %)/(Ni (at %)+Mn (at %)+Co (at %))

fraction of W=W_{B}=W (at %)/(Ni (at %)+Mn (at %)+Co (at %))

fraction of B=B_{B}=B (at %)/(Ni (at %)+Mn (at %)+Co (at %))

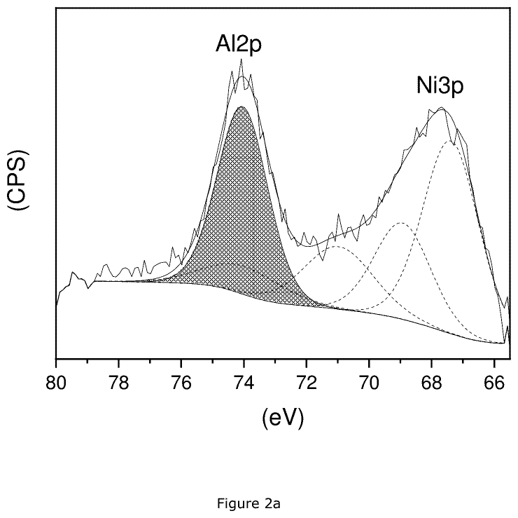

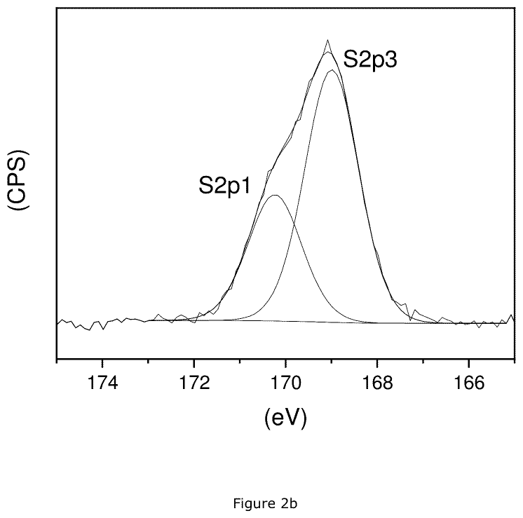

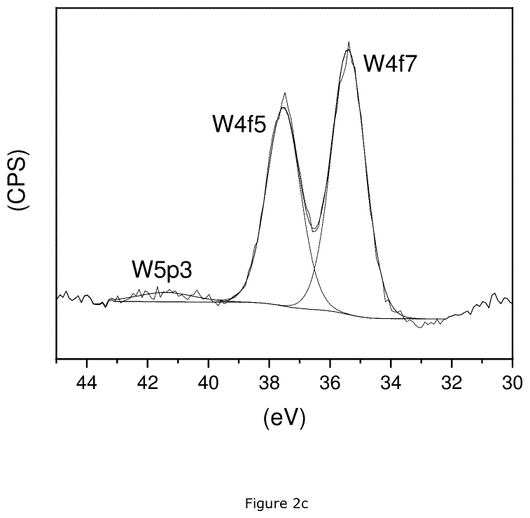

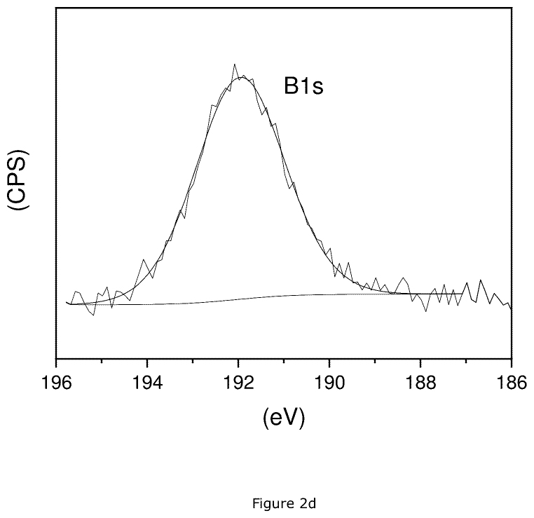

The information of XPS peak position can be easily obtained in the regions and components report specification after fitting is conducted. XPS graph of Al, S, W, and B are shown each in FIGS. 2a, 2b, 2c, and 2d, respectively.

### C) Coin Cell Testing

### C1) Coin Cell Preparation

For the preparation of a positive electrode, a slurry that contains a positive electrode active material powder, conductor (Super P, Timcal), binder (KF #9305, Kureha)—with a formulation of 96.5:1.5:2.0 by weight—in a solvent (NMP, Mitsubishi) is prepared by a high-speed homogenizer. The homogenized slurry is spread on one side of an aluminum foil using a doctor blade coater with a 170 μm gap. The slurry coated foil is dried in an oven at 120° C. and then pressed using a calendaring tool. Then it is dried again in a vacuum oven to completely remove the remaining solvent in the electrode film. A coin cell is assembled in an argon-filled glovebox. A separator (Celgard 2320) is located between a positive electrode and a piece of lithium foil used as a negative electrode. 1M LiPF₆ in EC/DMC (1:2) is used as electrolyte and is dropped between separator and electrodes. Then, the coin cell is completely sealed to prevent leakage of the electrolyte.

### C2) Testing Method

The testing method is a conventional “constant cut-off voltage” test. The conventional coin cell test in the present invention follows the schedule shown in Table 2. Each cell is cycled at 25° C. using a Toscat-3100 computer-controlled galvanostatic cycling station (from Toyo). The schedule uses a 1C current definition of 220 mA/g. The initial charge capacity (CQ1) and discharge capacity (DQ1) are measured in constant current mode (CC) at C rate of 0.1C in the 4.3V to 3.0V/Li metal window range.

The irreversible capacity IRRQ is expressed in % as follows:

$$IRRQ ( \% ) = \frac{( CQ 1 - DQ 1 )}{CQ 1} \times 100$$

TABLE 2
Cycling schedule for Coin cell testing method

| Charge | | | | Discharge | | | |
|---|---|---|---|---|---|---|---|
| | End | Rest | V/Li | | End | Rest | V/Li |
| C Rate | current | (min) | metal (V) | C Rate | current | (min) | metal (V) |
| 0.1 | — | 30 | 4.3 | 0.1 | — | 30 | 3.0 |

The invention is further illustrated by the following (non-limitative) examples:

### COMPARATIVE EXAMPLE 1

A high Ni compound CEX1, having the formula Li_{1+d}(Ni_{0.80}Mn_{0.10}Co_{0.10})_{1-d}O₂, is obtained through a double sintering process which is a solid-state reaction between a lithium source and a transition metal-based source running as follows:

1) Co-precipitation: a transition metal-based oxidized hydroxide precursor with metal composition of Ni_{0.80}Mn_{0.10}Co_{0.10} is prepared by a co-precipitation process in a large-scale continuous stirred tank reactor (CSTR) with mixed nickel-manganese-cobalt sulfates, sodium hydroxide, and ammonia.

2) Blending: the transition metal-based hydroxide and LiOH as a lithium source are homogenously blended at a lithium to metal M′ (Li/M′) ratio of 1.01 in an industrial blending equipment.

3) 1^{st} sintering: the blend is sintered at 730° C. for 12 hours under an oxygen atmosphere. The sintered powder is crushed, classified, and sieved so as to obtain a sintered intermediate product.

4) 2^{nd} sintering: the intermediate product is sintered at 830° C. for 12 hours under an oxygen atmosphere so as to obtain a sintered powder of agglomerated primary particles. The sintered powder is crushed, classified, and sieved so as to obtain CEX1 having a formula Li_{1.005}M′_{0.995}O₂ (d=0.005) with M′=Ni_{0.80}Mn_{0.10}Co_{0.10}. CEX1 has a D50 of 12.0 μm and a span of 1.24. CEX1 comprises a trace of sulfur obtained from the metal sulfate sources in the Step 1) co-precipitation process.

Optionally, a source of dopant can be added in the co-precipitation process in Step 1) or in the blending step in the Step 2) together with lithium source. Dopant can be added, for instance, to improve the electrochemical properties of the positive electrode active material powder product.

CEX1.1 is not according to the present invention.

CEX1.2, which is not according to the present invention, is prepared by the following procedure:
Step 1) Wet mixing: CEX1.1 is mixed with aluminum sulfate solution, which is prepared by dissolving 1000 ppm Al from Al₂(SO₄)₃ powder into 3.5 wt. % of deionized water with respect to the weight of CEX1.1.
Step 2) Heating: The mixture obtained from Step 1) is heated at 385° C. for 8 hours under an oxygen atmosphere followed by grinding and sieving so as to obtain CEX1.2 comprising about 1000 ppm Al with respect to total weight of EX1.2.

### EXAMPLE 1

EX1.1, which is according to the present invention, is prepared by the following procedure:
Step 1) Dry mixing: CEX1.1 is dry mixed with 2000 ppm W from WO₃ powder so as to obtain a dry mixture.
Step 2) Wet mixing: Dry mixture from Step 1) is mixed with aluminum sulfate solution, which is prepared by dissolving 600 ppm Al from Al₂(SO₄)₃ powder into 3.5 wt. % of deionized water with respect to the weight of CEX1.1 so as to obtain a wet mixture.
Step 3) Heating: The wet mixture obtained from Step 2) is heated at 385° C. for 8 hours under an oxygen atmosphere followed by grinding and sieving so as to obtain EX1.2.

EX1.2, which is according to the present invention, is prepared according to the same method as EX1.1, except that 3000 ppm W is added in the Step 1).

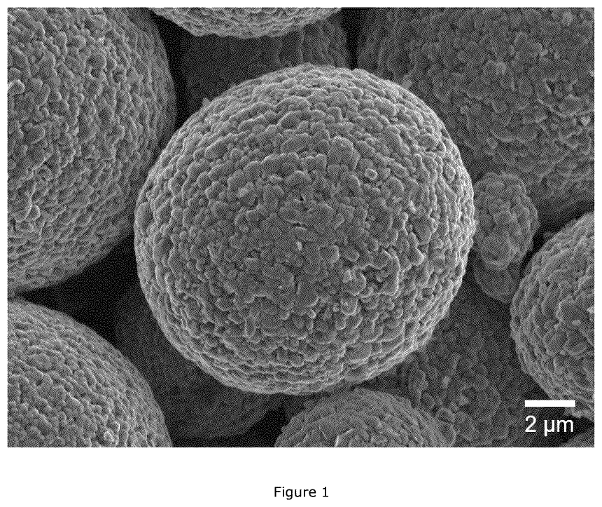

EX1.3, which is according to the present invention, is prepared according to the same method as EX1.1, except that 4000 ppm W is added in the Step 1). A SEM image was taken of EX1.3, see FIG. 1.

EX1.4, which is according to the present invention, is prepared according to the same method as EX1.1, except that 800 ppm Al is added in the Step 2).

EX1.5, which is according to the present invention, is prepared according to the same method as EX1.4, except that 3000 ppm W is added in the Step 1).

EX1.6, which is according to the present invention, is prepared according to the same method as EX1.4, except that 4000 ppm W is added in the Step 1).

### Example 2

EX2, which is according to the present invention, is prepared by the following procedure:
Step 1) Dry mixing: CEX1.1 is dry mixed with 4500 ppm W from WO₃ powder so as to obtain a dry mixture.
Step 2) Wet mixing: Dry mixture from Step 1) is mixed with 0.5 mol % S from sulfuric acid solution, which is prepared by dissolving a concentrated H₂SO₄ solution (98% concentration) into 3.5wt. % of deionized water with respect to the weight of CEX1.1, so as to obtain a wet mixture.
Step 3) Heating: The wet mixture obtained from Step 2) is heated at 285° C. for 8 hours under an oxygen atmosphere followed by grinding and sieving so as to obtain EX1.2.

### COMPARATIVE EXAMPLE 2

CEX2, which is not according to the present invention, is prepared according to the same method as EX2, except that the wet mixing Step 2) is omitted.

### Example 3

EX3, which is according to the present invention, is prepared by the following procedure:
Step 1) Dry mixing: CEX1.1 is dry mixed with 500 ppm B from H₃BO₃ and 4500 ppm W from WO₃ powder so as to obtain a dry mixture.
Step 2) Wet mixing: dry mixture from Step 1) is mixed with aluminum sulfate solution, which is prepared by dissolving 1000 ppm Al from Al₂(SO₄)₃ powder into 3.5 wt. % of deionized water with respect to the weight of the dry mixture.
Step 3) Heating: The wet mixture obtained from Step 2) is heated at 385° C. for 8 hours under an oxygen atmosphere followed by grinding and sieving so as to obtain EX3.

TABLE 3
Summary of the composition and the corresponding electrochemical
properties of the examples and comparative examples.

| | | | | Electrochemical | |
|---|---|---|---|---|---|
| | ICP | | | property | |
| | (mol %*) | | Soluble S | DQ1 | IRRQ |
| ID | Al | W | (mol %*) | (mAh/g) | (mAh/g) |
| CEX1.1 | 0.01 | 0.00 | 0.25 | 194.2 | 14.9 |
| CEX1.2 | 0.34 | 0.00 | 0.69 | 206.5 | 8.8 |
| EX1.1 | 0.27 | 0.11 | 0.58 | 207.7 | 8.6 |
| EX1.2 | 0.23 | 0.15 | 0.53 | 209.3 | 8.2 |
| EX1.3 | 0.22 | 0.23 | 0.50 | 209.1 | 8.0 |
| EX1.4 | 0.30 | 0.12 | 0.58 | 209.1 | 7.9 |
| EX1.5 | 0.30 | 0.19 | 0.59 | 207.1 | 7.9 |
| EX1.6 | 0.30 | 0.24 | 0.60 | 207.6 | 8.3 |
| EX2 | 0.00 | 0.23 | 0.65 | 207.1 | 9.2 |
| CEX2 | 0.00 | 0.20 | 0.23 | 199.4 | 12.0 |
| EX3 | 0.38 | 0.24 | 0.74 | 211.8 | 8.6 |

*Relative to molar contents of Ni, Mn, Co, Al, and W

TABLE 4
XPS analysis result of CEX1.2, EX1.4, and EX3 and the ratio with ICP analysis

| | Content by ICP ** | | | | Content by XPS ** | | | | Ratio XPS/ICP | | | |
|---|---|---|---|---|---|---|---|---|---|---|---|---|
| ID | Al_{A} | S_{A} | W_{A} | B_{A} | Al_{B} | S_{B} | W_{B} | B_{B} | Al_{B}/Al_{A} | S_{B}/S_{A} | W_{B}/W_{A} | B_{B}/B_{A} |
| CEX1.2 | 0.0034 | 0.0080 | 0.0000 | 0.0000 | 2.91 | 1.27 | 0.00 | 0.00 | 839 | 158 | — | — |
| EX1.4 | 0.0030 | 0.0071 | 0.0013 | 0.0000 | 1.44 | 1.78 | 0.22 | 0.00 | 475 | 251 | 175 | — |
| EX3 | 0.0038 | 0.0094 | 0.0024 | 0.0039 | 7.75 | 4.38 | 3.72 | 1.39 | 2042 | 438 | 580 | 965 |

** molar content of specified element relative to molar contents of Ni, Mn, and Co

TABLE 5
XPS peak position for CEX1.2, EX1.4, and EX3

Peak position as obtained from fitting (eV)

| ID | Al2p | S2p3 | W4f7 | B1s |
|---|---|---|---|---|
| CEX1.2 | 73.9 | 169.2 | — | — |
| EX1.4 | 74.0 | 169.0 | 35.4 | — |
| EX3 | 74.2 | 169.1 | 35.2 | 192.0 |

Table 3 summarizes the composition of Al, W, and soluble S in the examples and comparative examples and their corresponding electrochemical properties. EX1.1 to EX1.6 and EX2 comprising W in a content between 0.05 mol % and 0.50 mol %, relative to M′, and soluble S in a content between 0.30 mol % and 2.00 mol %, relative to M′, can achieve the objective of the present invention, which is to provide a positive electrode active material having an improved first charge capacity of at least 207 mAh/g. Moreover, EX3 also comprises 0.4 mol % B which further improves the electrochemical properties.

Table 4 summarizes the XPS analysis results of CEX1.2, EX1.4, and EX3 showing Al, S, B, and W atomic ratio with respect to the total atomic fraction of Ni, Mn, and Co. The table also compares the result with that of ICP. The atomic ratio higher than 0 indicating said Al, S, B, and W are presence in the surface of the positive electrode active material as associated with the XPS measurement which signal is acquired from the first few nanometers (e.g. 1 nm to 10 nm) of the uppermost part of a sample, i.e. surface layer. On the other hand, Al, S, B, and W atomic ratio obtained from ICP measurement is from the entire particles. Therefore, the ratio of XPS to ICP of higher than 1 indicating said elements Al, S, B, or W presence mostly on the surface of the positive electrode active material. The ratio of XPS to ICP of higher than 1 is observed for Al, S, and W in EX1.4. Similarly, the ratio of XPS to ICP of higher than 1 is observed for Al, S, B, and W in EX3.

Table 5 shows the Al2p, S2p3, W4f7, and B1s XPS peak position for CEX1.2, EX1.4, and EX3 as obtained according to XPS analysis description in this invention.

1-28. (canceled)

29. A positive electrode active material powder for lithium-ion rechargeable batteries, wherein the positive electrode active material comprises Li, S, M′, and O, wherein M′ consists of:
Ni in a content x between 60.0 mol % and 95.0 mol %, relative to M′
Co in a content y between 0.0 mol % and 25.0 mol %, relative to M′,
Mn in a content z between 0.0 mol % and 25.0 mol %, relative to M′,
W in a content a of 0.05 mol % or more, relative to M′
D in a content b between 0.0 mol % and 2.0 mol %, relative to M′, wherein D comprises at least one element of the group consisting of: Al, B, Ba, Ca, Cr, F, Fe, Mg, Mo, Nb, Si, Sr, Ti, Y, V, Zn and Zr, and,
wherein x, y, z, a, and b are measured by ICP,
wherein x+y+z+a+b is 100.0 mol %,
wherein the positive electrode active material comprises soluble sulfur in a content of 0.30 mol % or more, relative to M′.

30. Positive electrode active material according to claim 29, wherein the soluble sulfur content is equal to a decrease of a S content relative to M′ as determined by ICP after having dispersed the positive electrode active material powder into deionized water so as to obtain a solution, said solution being stirred for at least 5 minutes at 25° C., filtered said positive electrode active material powder, and dried said positive electrode active material powder.

31. Positive electrode active material according to claim 29, wherein x is between 75 mol % and 90 mol %.

32. Positive electrode active material according to claim 29, wherein the soluble sulfur content is 0.50 mol % or more, relative to M′.

33. Positive electrode active material according to claim 29, wherein a is 0.10 mol % or more.

34. Positive electrode active material according to claim 29, wherein said positive electrode active material comprises Al in a content of 0.10 mol % or more, relative to M′.

35. Positive electrode active material according to claim 29, wherein said positive electrode active material comprises Al in a content of at most 1.0 mol %, relative to M′.

36. Positive electrode active material according to claim 29, wherein said positive electrode active material comprises B in a content of at least 0.05 mol %, relative to M′.

37. Positive electrode active material according to claim 29, wherein said positive electrode active material comprises B in a content of at most 1.5 mol %, relative to M′.

38. Positive electrode active material according to claim 29, said material having:
a S content S_{A} and a W content W_{A}, wherein S_{A} and W_{A} are determined by ICP analysis, wherein S_{A} and W_{A} are expressed as molar fractions compared to the sum of x and y and z,
An average S fraction S_{B} and an average W fraction W_{B}, wherein S_{B} and W_{B} are determined by XPS analysis, wherein S_{B} and W_{B} are expressed as molar fractions compared to the sum of the fractions of Co, Mn and Ni as measured by XPS analysis,
wherein the ratio S_{B}/S_{A}>1.0,
wherein the ratio W_{B}/W_{A}>1.0.

39. Positive electrode active material according to claim 38, wherein the ratio S_{B}/S_{A} is at least 1.5

40. Positive electrode active material according to claim 38, wherein the ratio W_{B}/W_{A} is at least 1.5.

41. Positive electrode active material according to claim 38, wherein the ratio S_{B}/S_{A} is at most 600.

42. Positive electrode active material according to claim 38, wherein the ratio W_{B}/W_{A} is at most 700.

43. Positive electrode active material according to claim 29, said material having:
an Al content Al_{A}, wherein Al_{A} is determined by ICP analysis, wherein Al_{A}is expressed as molar fractions compared to the sum of x and y and z,
An average Al fraction Al_{B}, wherein Al_{B} is determined by XPS analysis, wherein Al_{B} is expressed as molar fractions compared to the sum of the fractions of Co, Mn and Ni as measured by XPS analysis,
wherein the ratio Al_{B}/Al_{A}>1.0.

44. Positive electrode active material according to claim 43, wherein the ratio Al_{B}/Al_{A} is at least 3.0.

45. Positive electrode active material according to claim 43, wherein the ratio Al_{B}/Al_{A} is at most 2400.

46. Positive electrode active material according to claim 29, wherein the positive electrode active material comprises said soluble sulfur in a content of 2.00 mol % or less, relative to M′.

47. Positive electrode active material according to claim 29, wherein the positive electrode active material comprises said soluble sulfur in a content of 1.00 mol % or less, relative to M′.

48. Positive electrode active material according to claim 29, wherein a is 0.50 mol % or less.

49. Positive electrode active material according to claim 29, wherein y is between 5 mol % and 10 mol %, relative to M′.

50. Positive electrode active material according to claim 29, said material having:
a B content B_{A}, wherein B_{A} is determined by ICP analysis, wherein BA is expressed as molar fractions compared to the sum of x and y and z,
an average B fraction B_{B}, wherein B_{B} is determined by XPS analysis, wherein B_{B} is expressed as molar fractions compared to the sum of the fractions of Co, Mn and Ni as measured by XPS analysis,
wherein the ratio B_{B}/B_{A}>1.0.

51. Positive electrode active material according to claim 50, wherein the ratio B_{B}/B_{A} is at least 100.

52. Positive electrode active material according to claim 50, wherein the ratio B_{B}/B_{A} is at most 1500.

53. A process for the manufacturing of a positive electrode active material according to claim 29, comprising the consecutive steps of
Preparing a first sintered lithium transition metal-based oxide compound,
mixing said first sintered lithium transition metal-based oxide compound with a source of tungsten, a source of sulfate ion, and with water, thereby obtaining a mixture, and
heating the mixture in an oxidizing atmosphere in a furnace at a temperature between 350° C. and less than 500° C., for a time between 1 hour and 20 hours so as to obtain the positive electrode active material powder.

54. A process according to claim 53, wherein lithium metal-based oxide compound is mixed with a source of boron and a source of tungsten and a source of sulfate ion.

55. A battery comprising the positive electrode active material according to claim 29.

56. An electric vehicle or a hybrid electric vehicle comprising the battery according to claim 55.
